(19) United States
(12) Patent Application Publication
(10) Pub. No.: US 2014/0338608 A1
(43) Pub. Date: Nov. 20, 2014

(54) PORTABLE PET WASTE DISPOSAL DEVICE

(71) Applicant: ModProducts, LLC, Brooklyn, NY (US)

(72) Inventors: Richard Williams, Brooklyn, NY (US); Brett Teper, Brooklyn, NY (US)

(73) Assignee: ModProducts, LLC, Brooklyn, NY (US)

(21) Appl. No.: 14/278,949

(22) Filed: May 15, 2014

Related U.S. Application Data
(60) Provisional application No. 61/824,297, filed on May 16, 2013.

(51) Int. Cl. A01K 1/01; A01K 23/00

(52) U.S. Cl. CPC A01K 1/0125; A01K 23/005
USPC 119/168

(57) ABSTRACT

A foldable and sealable pet waste disposal case is disclosed. When in the open position, a pet can use open surface as a replacement for an outdoor surface to relieve itself. After use, the case can then be sealably closed when not in use, and the liquid retained in the case can be discarded when desired. The case includes an exit port which allows the waste liquid to be decanted from the case and a port which allows water to be introduced therein for purposes of cleaning the device.

### CROSS-REFERENCE TO RELATED APPLICATIONS

This application claims the benefit of priority from U.S. Provisional Application Ser. No. 61/824,297, filed May 16, 2013, the contents of which are incorporated herein by reference.

### BACKGROUND OF THE INVENTION

Various products exist which allow pets to relieve themselves indoors. These products are traditionally used as a convenience to pet owners so that the pet owners do not have to take their pet outside. For example, these products include absorbent pads and devices that include sod or artificial grass which allow liquid to seep into an associated bin. However, absorbent pads can be susceptible to leakage, which in turn can cause an unsanitary environment or possible damage to flooring. The grass covered devices typically take up a great deal of space and are not easily storable or portable. Thus, there continues to be a need for improved pet waste receptacles.

### SUMMARY OF THE INVENTION

The present invention relates to a pet waste disposal case that is portable and easy to store. The case includes a first and a second shell that are hingeably attached to each other. The case further includes permeable surfaces, such as grates, arranged on the shells. The grates thus allow a pet to stand thereon when the case is in the open position, and relieve itself. Liquid waste passes through the holes of the grate and collects initially in the shell before collecting in the chambers when each side of the case is brought upward toward each other with the hinge region forming a base or bottom of the case for standing in an upright position. Thus, as the two halves of the case are closed upon each other in a vertical direction, the fluids are directed by gravity to the chambers. More specifically, the chambers included in each of the first and second shells are below the permeable surfaces affixed thereon. The chambers are formed by arranging a baffle sealably attached to three of the side walls of each shell with the baffle being sloped in a downward direction toward or with respect to the bottom wall. The chambers also have an opening in the direction of the center of the shell so that liquid passing through the permeable surfaces is collected in the chamber when the case is in a closed upright position.

After use, the case can be folded and sealed. The liquid waste retained in the case can then be discarded via an exit port positioned toward the top of the case in one of the shells. Stated alternatively, the exit port is distal to the chamber within the case. The exit port can be uncapped and the waste liquid can be poured from the case into a suitable receptacle such as toilet or other waste disposal container. After the liquid waste is discarded, water and/or a cleaning solution can be added to the sealed case through an inlet to clean and sanitize the case for future use. Solid waste on the grate(s) is preferably removed and, if necessary, the region of the permeable surface is cleaned prior to returning the case to the closed position.

One advantage of the present invention is that it provides a convenient, hygienic, portable and storable means for pets to relieve themselves.

### BRIEF DESCRIPTION OF THE DRAWINGS

The present invention will be further understood and appreciated by reading the following description in conjunction with the accompanying drawings, in which:

FIG. 1 is a perspective view of a pet waste disposal case of the present invention in a closed state;

FIG. 2 is a perspective view of the case in an open state with grates in place;

FIG. 3 is an exploded perspective view of the case in an open state;

FIG. 4. is a perspective view of the case in an open state with grates removed;

FIG. 5 is a side view of the case in an open state;

FIG. 6 is a cross-sectional side view of the case in an open state;

FIG. 7 is a top view of the case in an open state;

FIG. 8 is a bottom view of the case in an open state;

FIG. 9 is a side view of the case in an open state showing the top latch;

FIG. 10 is a side view of the case in a closed state;

FIG. 11 is a second side view of the case in a closed state showing the top latch and exit port;

FIG. 12 is a third side view of the case in a closed state showing the bottom hinge;

FIG. 13a is a bottom view of a second embodiment of the case with the locks or latches in the closed position;

FIG. 13b is a sectional side view of the case shown in 13a, taken along view A-A;

FIG. 13c is a side view of the second embodiment of the case showing the path of a lock or latch moving toward the open position;

FIG. 14a is a bottom view of the second embodiment of the case with the locks or latches in an intermediate open position;

FIG. 14b is a sectional side view of the case shown in 14a, taken along view B-B;

FIG. 14c is a side view of the second embodiment of the case with the lock or latch in the intermediate open position;

FIG. 15a is a bottom view of the second embodiment of the case with the locks or latches in the open position resting against recesses in the bottom of the case;

FIG. 15b is a sectional side view of the case shown in 15a, taken along view C-C; and

FIG. 15c is a side view of the second embodiment of the case with a lock or latch in the open position resting against a recess in the bottom of the case.

### DETAILED DESCRIPTION OF THE INVENTION

Broadly, the present invention is directed to a pet waste disposal case, which includes a first shell that has a bottom wall and side walls which extend away from the bottom wall in a same direction so as to form a first rim, a second shell that has a bottom wall and side walls which extend away from the bottom wall in a same direction so as to form a second rim, a first permeable surface affixed to the first rim of the first shell, and a second permeable surface affixed to the second rim of the second shell. Each shell has a pitched interior that guides liquid toward the openings of the otherwise sealed hollow chambers. This shape prevents liquid from escaping when the case is being closed.

The first shell and the second shell can be hingeably attached to each other by a preferably plastic or rigid hinge that is affixed to the first rim and the second rim. The first and second rims are substantially aligned such that the case is sealable when in a closed position. The case can include a first cap for sealing the first opening or exit port in one of the shells which form the case and a second cap for sealing a second opening in the case designed to allow water or other disinfecting solutions to be placed into the case for purposes of cleaning. The second opening is preferably located on the bottom portion of one of the shells, more preferably, the shell having the exit port thereon, so as to allow larger volumes of water or disinfecting/cleansing solutions to be introduced into the case when desired.

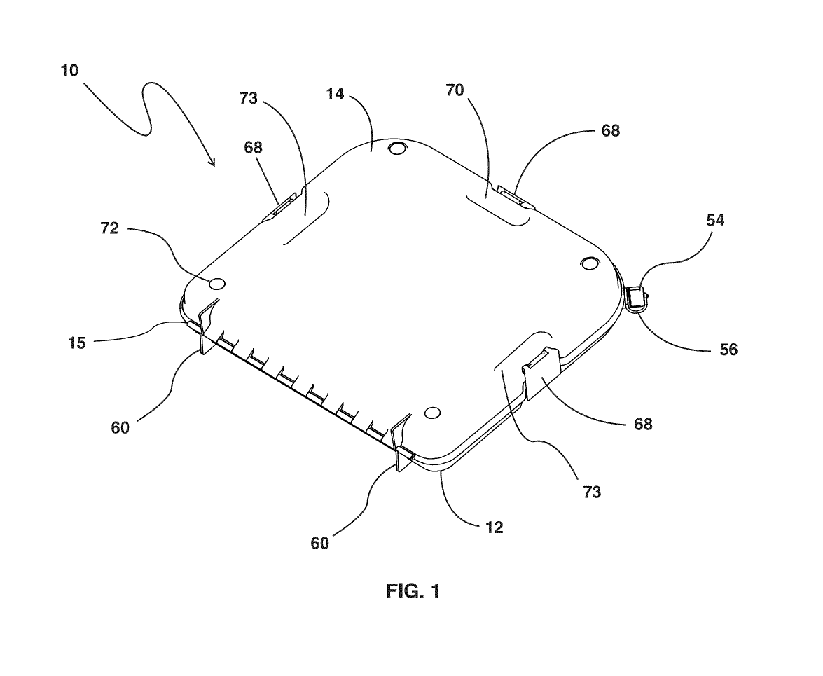

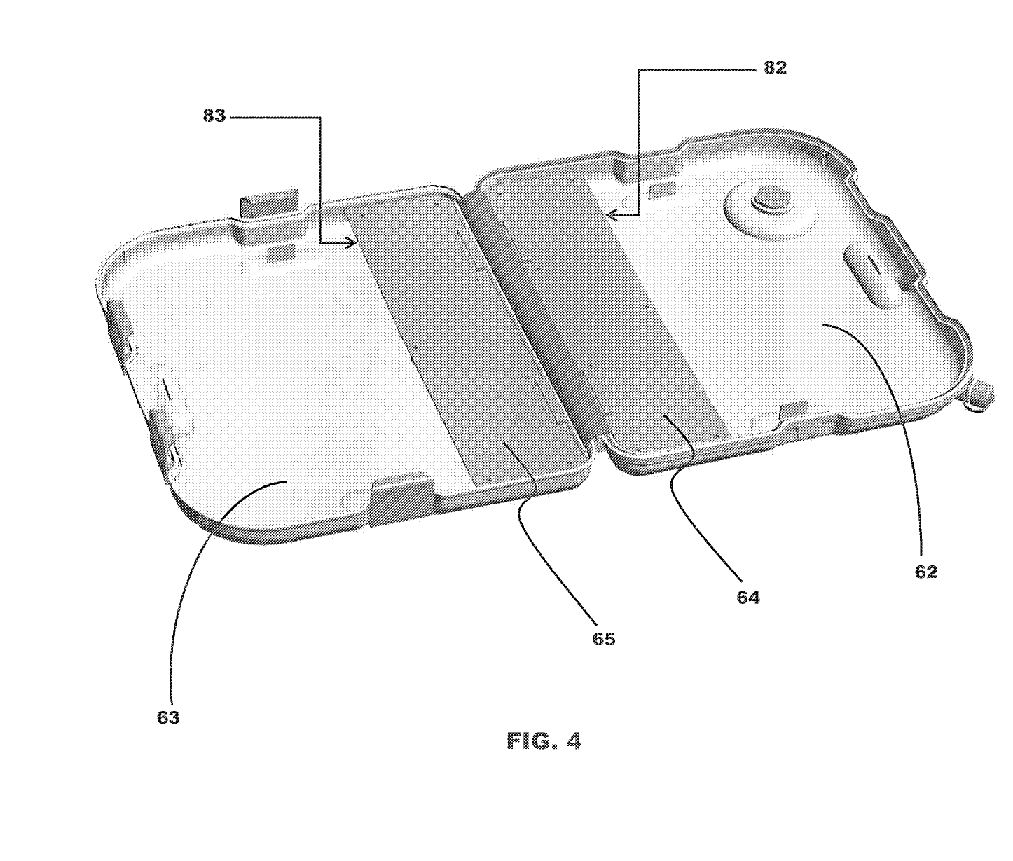

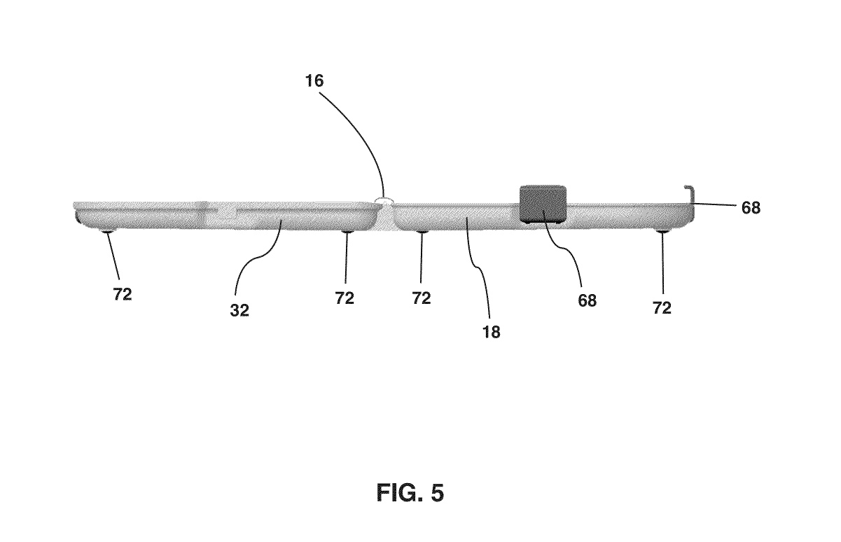

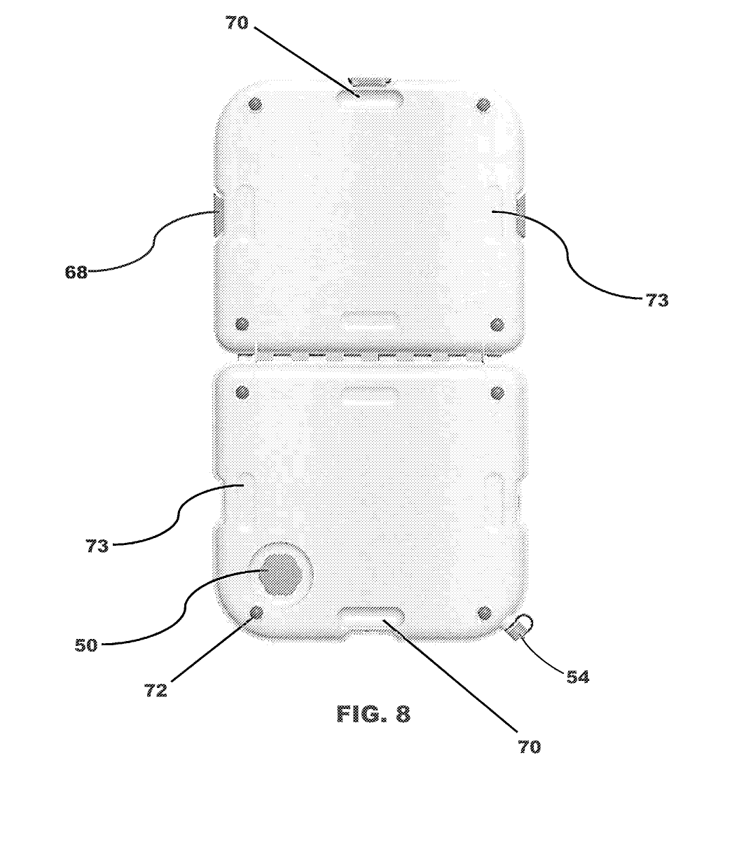

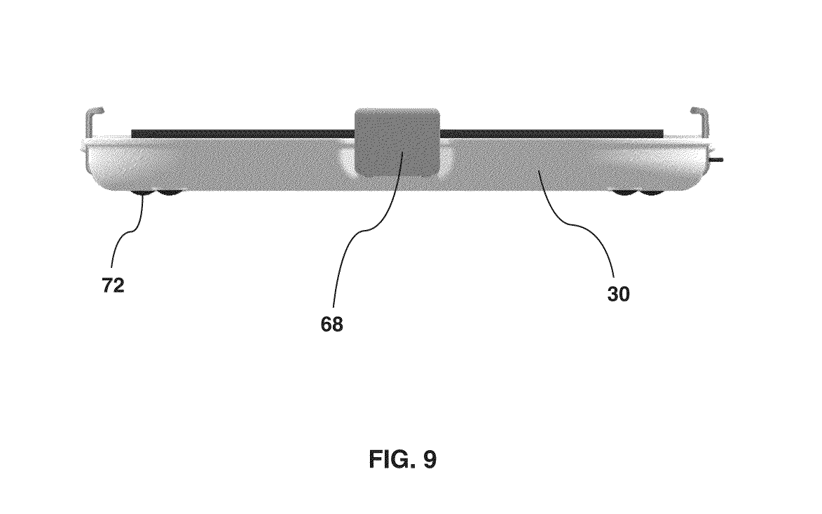

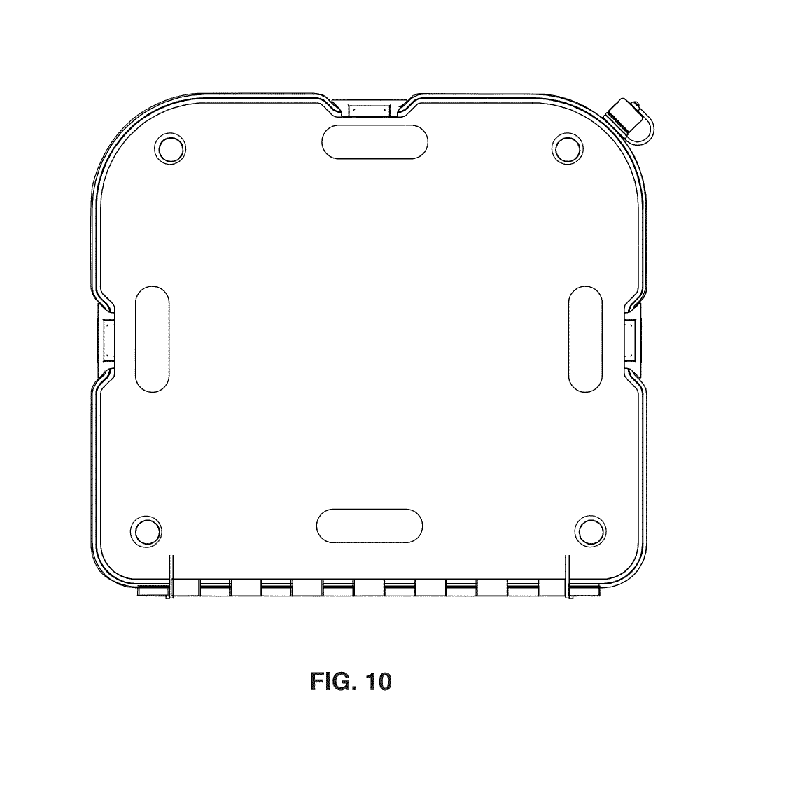

Turning now to the figures, it can be seen that the case 10 has a first shell 12 and a second shell 14. A first cap 50 and a second cap 54 both illustrated in FIG. 8 are shown fastened to the first shell 12. A locking mechanism also referred to herein as the lock or latch, 68, functions to ensure that the case 10 remains sealed in a closed position when desired, is also shown. In many embodiments, the locking mechanisms 68 can be any suitable latching mechanism or sliding lock know to those of ordinary skill. FIGS. 1-3, for example, show a single locking mechanism 68 arranged on the top of the closed case. FIGS. 4 and 13a-15c, for example, illustrate an alternative embodiment wherein the top portion of the device includes two locking mechanisms, preferably approximately equally spaced apart. Moreover, the case 10 has handles 70 for easy gripping and transportability, which are formed on the first shell 12 and the second shell 14.

Cases made in accordance with the present invention can also optionally include feet 72 that are affixed to an external surface of the first shell 12 and the second shell 14 to ensure the case 10 does not slide when in use and does not damage surfaces it is placed on. The feet 72 can be made any desirable malleable material, including rubber or silicone. Alternatively, the case 10 can be formed so that the feet 72 are included as part of the mold.

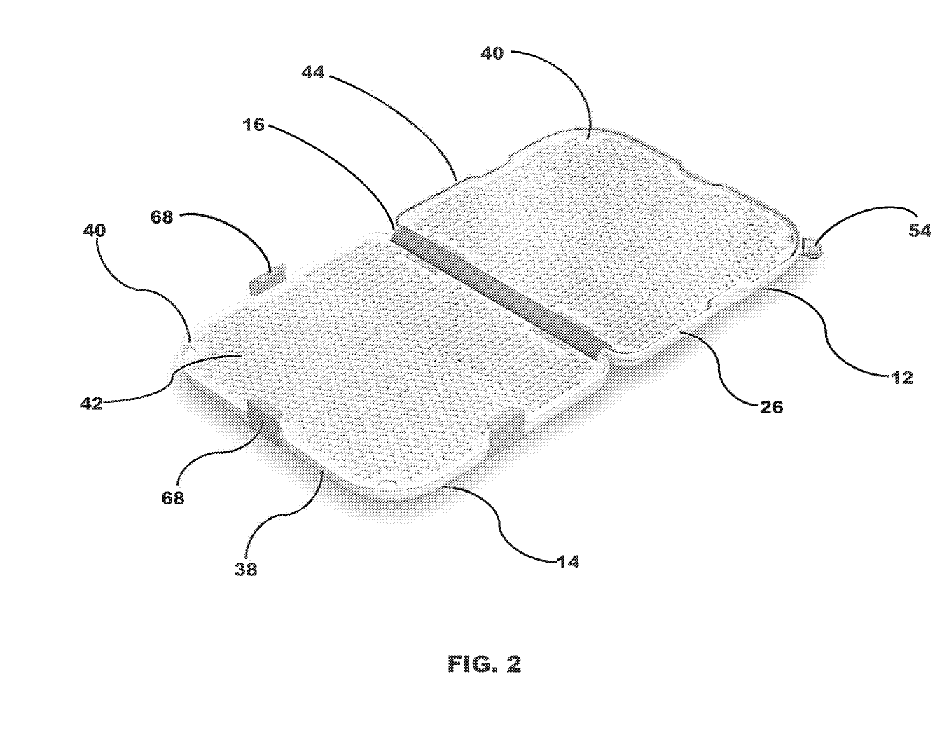

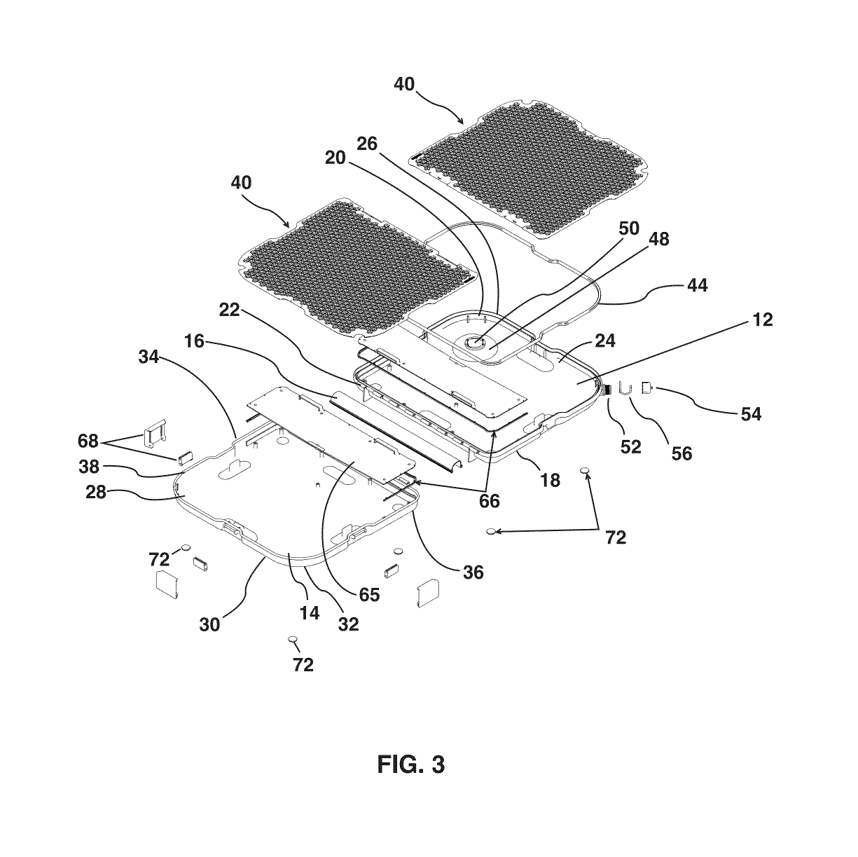

As can be seen in FIGS. 2 and 3, the first shell 12 and the second shell 14 are hingeably connected to each other by any known means, such as a plastic or metal hinge 15. A silicone or other suitable material flap 16 as shown in the figures can be used to cover the hinges when the device is in the open position. The first shell 12 has sidewalls 18, 20, 22, 24 (See, FIG. 3) that extend from a base 19 toward a first rim 26 formed by the sidewalls 18, 20, 22, 24. Similarly, the second shell 14 has a base 28 and sidewalls 30, 32, 34, 36 (See, FIG. 3) that extend from the base 28 toward a second rim 38 formed by the sidewalls 30, 32, 34, 36. The shells 12, 14 can be made of any desirable material and formed from any known method of manufacture, including, but not limited to antimicrobial blow molded plastic.

Also, as shown in FIGS. 2 and 3, grates 40, which have a plurality of holes 42, are arranged on the first rim 26 and the second rim 38. The holes 42 can be any size or shape such as circles or hexagons suitably sized to allow pets to comfortably walk thereon. For example, the holes may be about 12 mm in diameter in many embodiments. Moreover, although grates 40 are shown, any known permeable surface can be used in addition to the grates 40 or in place of the grates 40. Additionally, a seal, or gasket, 44 surrounds the grates 40 and is affixed to the first rim 26 and the second rim 38. The seal 44 can be made out of any known material, such as silicone, which prevents leakage when the case 10 is closed. If desired, the grates 40 can be releaseably affixed. Thus, allowing replacement or easier cleaning apart from the case 10.

As can be seen, for example, in FIG. 3, the first shell 12 has a first opening, or valve, 48, which acts as an inlet and is sealable by any known means. For example, the first opening 48 can have external threading and can be sealed by the cap 50 that has an internal threading, providing a screw connection between the first opening 48 and the cap 50. Alternatively, the first opening 48 can be sealed by a lid or a hinged door. The first shell 12 has a second opening or exit port or exit valve 52, which acts as an outlet and is also sealable by any known means. For example, the second opening or exit port 52 can have external threading and can be sealed by the lid 54 that has an internal threading, providing a screw connection between the second opening 52 and the lid or cap 54. The second opening or exit port is positioned toward the top of the case when the case is in a closed position with feet 60 allowing the case to remain in an upright position. This arrangement advantageously facilitates tilting of the case forward by the user when it is desired to remove the unwanted liquid therein, which in turn draws the liquid from both sealed chambers and out of the case via the exit port or second opening. Further, if a cap, i.e. 50 or 54, is associated with the openings 48, 52, the cap can also be attached to the openings 48, 52 by any known means, such as a lanyard 56, to ensure it is not misplaced.

Alternatively, the second opening or exit port 52 can also be sealed by a lid which is hingeably attached to shell 12 and can snap into exit port 52 to sealably close the vessel. After disposing of the liquid waste collected, the first opening 48 can be filled with water or a cleaning agent, such as detergent, soap, or vinegar. The design of the case 10 allows for filling with water in most bathroom sinks with low clearance faucets. Upon filling the case 10 and sealing the first opening 48 and the second opening 52, the case can be cleaned by shaking. To facilitate this cleaning action, the first and second shell portions include finger impressions 72 so that each side of the case is provided with additional means for gripping the case while shaking. After a satisfactory period of time of cleaning, the liquid can be drained through the second opening 52.

FIG. 4 for example illustrates the case 10 in an open position with the grates removed to show the inner surfaces 62 and 63 of the first and second shells 12 and 14 having sloped contours to direct liquid away from and not collect in the corners of the inner surfaces 62 and 63 cause the liquid to travel toward the chambers 82 and 83.

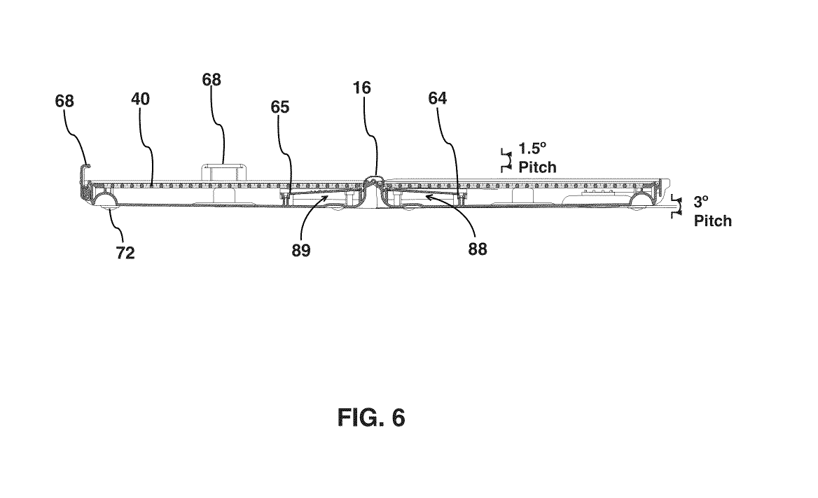

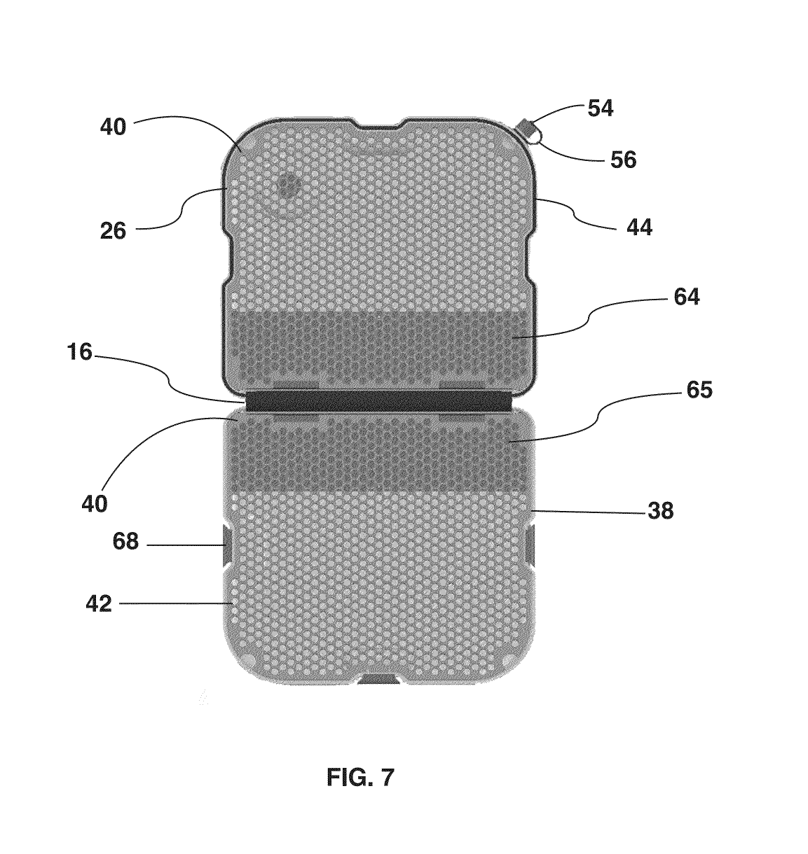

The chambers are formed in what can be considered the bottom portion (when the device is upright) of half of the case. Each of the first and second shells have a chamber below the permeable surfaces affixed thereon. The chambers are formed by a sealably affixing a baffle 64 and 65 to three of the side walls 18, 20 and 22 of shell 12 and side walls 32, 34 and 36 of shell 14. As shown in FIG. 6, each baffle is sloped with respect to the bottom wall so as to allow liquid falling on top thereof through the grates will drop into the center portion of the respective shells before being captured in the chamber when the device is moved to the closed position. The capture of the liquid is facilitated by having openings 88 and 89 in the direction of the center of the respective shell. The chambers therefore not only collect liquid but also aid in preventing spillage of the liquid when opening or closing the case 10.

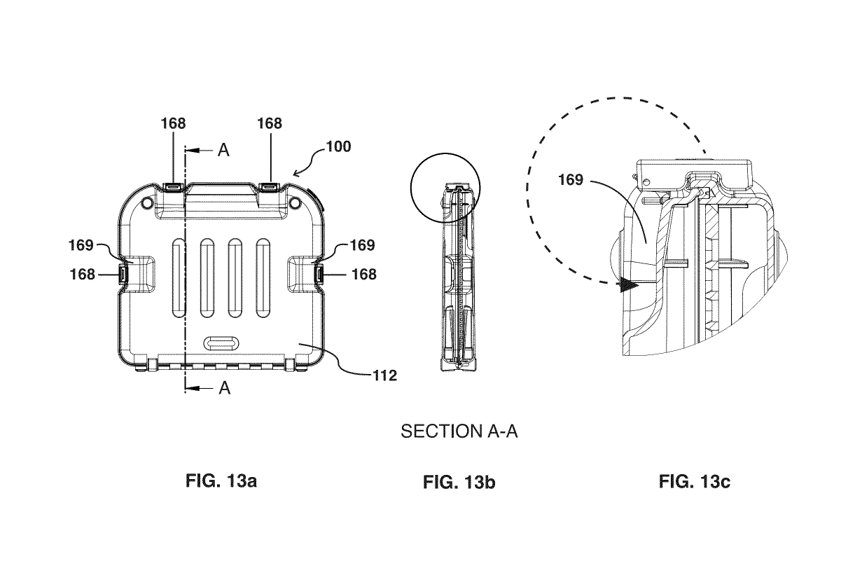

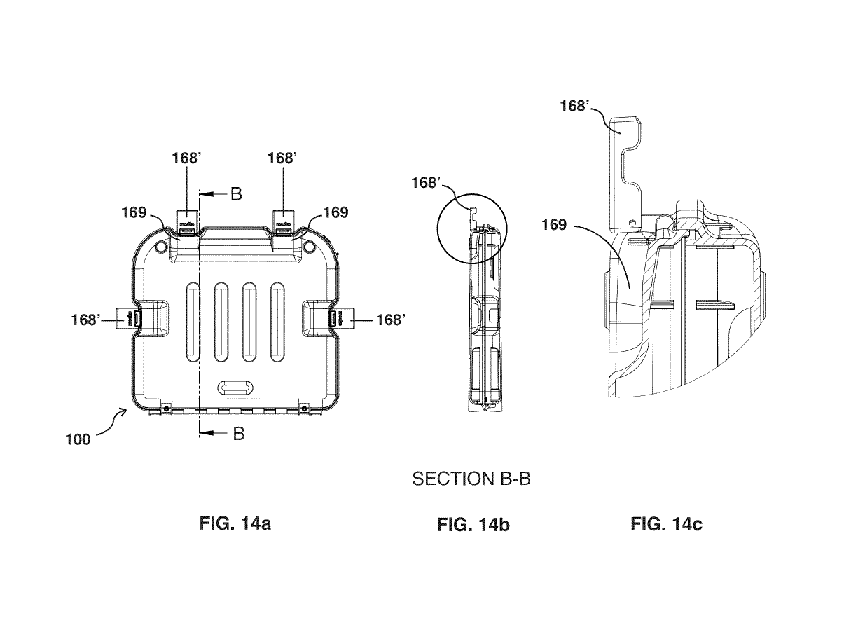

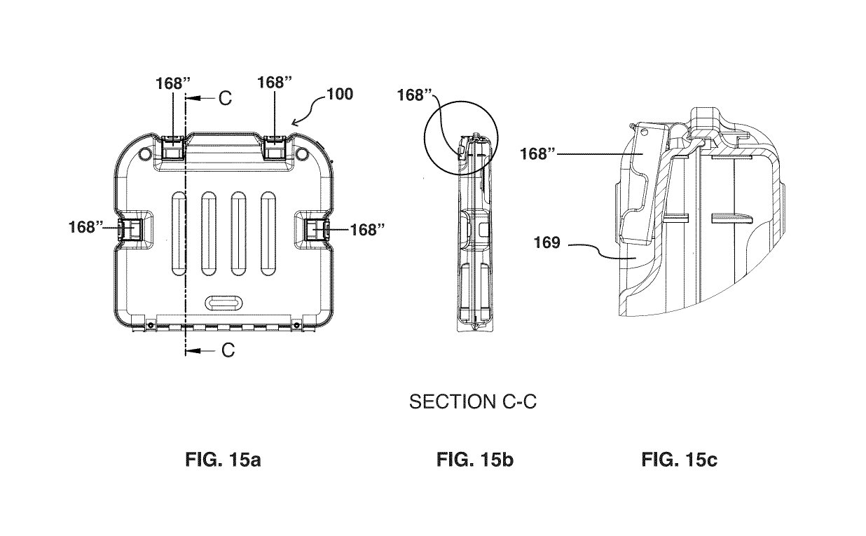

A still further aspect of the invention is now described with references to FIGS. 13a-15c. FIGS. 13a and 13b show device 100 in the closed position with latches 168 engaging both the upper and lower portions of the device. FIG. 13c shows the path of the latch toward a recess area 169 in the lower halve of the device, designated as the first shell 112. The device 100 is thus provided with a plurality of locks or latches 168 capable of being moved from a first position which securely keeps the device closed to an intermediate open position 168′ shown in FIGS. 14a, 14b, and 14c. As shown in FIGS. 15a, 15b and 15c, the path of the latches continues toward the secured open position wherein the locks or latches are frictionally fastened into the recess areas 169 found on the underside the device. Secure placement of the latches under the device when in the open or pet ready use state removes potential obstacles when the devices placed in an area where foot traffic exists.

Essentially, the latches fold away to avoid creating protrusions that may get in the way of humans or become toys for the animal.

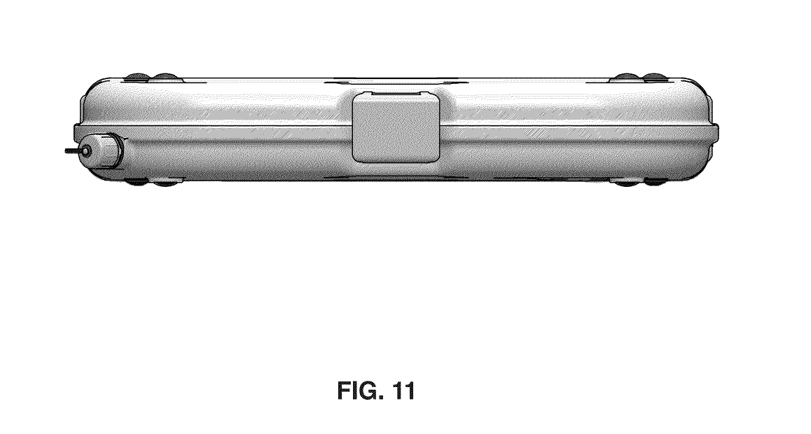

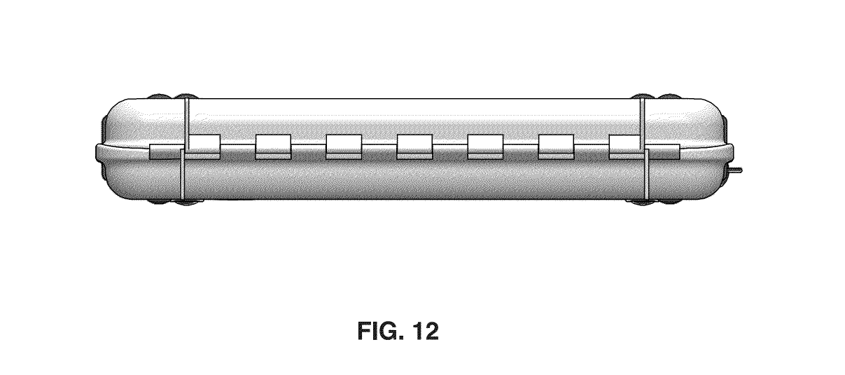

The figures also provide additional disclosure relating to various aspects of the device already described herein. For example, FIG. 8 shows the feet 72 are affixed to or formed as part of the first shell and second shell as well as the first cap 50 and the second cap 54 covering their respective ports. FIG. 11 shows the top case, handle and locking mechanism.

The present invention has been described with reference to some preferred embodiments. It should be understood that the scope of the present invention is broadly defined by the claims and is not intended to be limited to the embodiments disclosed herein.

What is claimed:

1. A pet waste disposal case, comprising:
a first shell having a bottom wall and side walls extending away from the bottom wall in a same direction so as to form a first rim;
a second shell having a bottom wall and side walls extending away from the bottom wall in a same direction so as to form a second rim;
a first permeable surface affixed to the first rim of the first shell;
each of said first and said second shells having a chamber below the permeable surfaces affixed thereon, said chambers being formed by a baffle sealably attached to three of the side walls of each shell and said baffle being sloped with respect to the bottom wall; said chambers further having an opening in the direction of the center of the shell; whereby the first shell and the second shell are hingeably attached to each other and the first rim and the second rim are substantially aligned such that the case is sealable in a closed position.

2. The case of claim 1, wherein the first permeable surface is a first grate having a plurality of holes and the second permeable surface is a second grate having a plurality of holes.

3. The case of claim 2, wherein the plurality of holes are circular or hexagonal in shape.

4. The case of claim 1, wherein the first shell has a first sealable opening extending through the bottom wall of the first shell and a second sealable opening arranged distal to the chambers.

5. The case of claim 1, wherein the first shell has a first seal that extends around the circumference of the first rim and the second shell has a second seal that extends around the circumference of the second rim.

6. The case of claim 1, wherein the first shell and the second shell have feet so as to prevent the case from sliding in an open position and to prevent damage to a surface the case is placed on.

7. The case of claim 1, further comprising a lock or latch to ensure the case remains sealed in the closed position.

8. The case of claim 1, wherein the locking mechanism includes a plurality of latches disposed on the outer sides of the case.

9. The case of claim 1, wherein the first shell includes a first port for discharging liquids from the case.

10. The case of claim 9, wherein the first shell includes a second part for liquids therein when the case is in the closed position.

11. The case of claim 7, wherein the long comprises a latch capable of being secured in a recess under the shell when the case is in an open position.
